(19) United States
(12) Patent Application Publication
(10) Pub. No.: US 2008/0319845 A1
(43) Pub. Date: Dec. 25, 2008

(54) PRINTING INCENTIVE AND OTHER INCENTIVE METHODS AND SYSTEMS

(75) Inventors: Christopher Alan Adkins, Lexington, KY (US); Frank Edward Anderson, Sadieville, KY (US); Robert Lee Cornell, Lexington, KY (US); Curtis Ray Droege, Richmond, KY (US); Timothy Lowell Strunk, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc., Lexington, KY (US)

(21) Appl. No.: 11/767,558

(22) Filed: Jun. 25, 2007

(51) Int. Cl. G06Q 30/00

(52) U.S. Cl. 705/14

(57) ABSTRACT

Embodiments of the invention provide printing incentive methods and systems. In one embodiment, a method of providing advertising content to a customer can be provided. The method can include receiving information associated with a customer. In addition, the method can include receiving information associated with at least one advertiser. Furthermore, the method can include associating at least one keyword with the at least one advertiser. Moreover, the method can include comparing the at least one keyword to a portion of information associated with the customer. Further, the method can include outputting advertising content to the customer based at least in part on the comparison.

### FIELD OF THE INVENTION

The invention relates generally to computer printers, and more particularly, to printing incentive and other incentive methods and systems.

### BACKGROUND OF THE INVENTION

Computer printers are well known in the prior art and include dot-matrix printers, piezo-electric ink jet printers, laser printers, thermal ink jet printers, handheld ink jet printers, and other ink jet printing devices. When using an ink jet printing device, an ink jet cartridge can be installed or otherwise mounted to the ink jet printing device to provide a supply of ink. On a periodic basis, the ink supply of the ink jet cartridge may become low or depleted. In these instances, the ink jet cartridge must be replaced to replenish the supply of ink.

The consumer marketplace has several unique characteristics which may drive consumers to seek and join incentive programs. One characteristic is that relatively low end ink jet printers and associated supplies cost relatively less than color and mono ink jet printers and associated supplies. The price disparity between the these types of ink jet printers can result in customer dissatisfaction with the relatively expensive ink jet printers and associated supplies. Another characteristic of the marketplace is increased competition between ink jet printer manufacturers. This may be caused by numerous low cost “clone” ink jet printers and associated supplies being introduced to the market. Yet another characteristic of the market is the anticipated worldwide growth in aftermarket share by non-OEMs (original equipment manufacturers). One study has projected that over 30% of worldwide sales of ink jet cartridges and mono toner cartridges are non-OEM.

One ink jet printer manufacturer has announced an incentive program intended to improve customer loyalty. This conventional program can permit customers to accumulate program points towards future discounts in purchases of ink jet printer supplies, such as ink, toner, or paper. However, the program is believed to be limited to orders of approximately US $50 or more, and is further limited to orders made in the most recent 12 month period.

Other incentives, programs, and models have been offered in the ink jet printer industry. Among these other incentives, programs, and models is a subsidized photo printing business model. This business model relates to a method of revenue generation through the use of “sliding scale subsidies”.

Another incentive, program, or model is to offer user discounts which can be inversely proportional to the length of time from a previous user purchase to the next user purchase. Relatively higher discounts can be offered to users having the shortest time between purchases. Further details of this model and method are disclosed in U.S. patent application Ser. No. 10/342,496, filed Jan. 15, 2003 and entitled, “Method For Reducing The Cost Of Imaging For Customers.”

In the competitive marketplace for ink jet printers and associated supplies, customers have numerous choices regarding printers and printer supplies. The apparent widespread availability can tend to drive down the prices of such printers and supplies. As a result, it is becoming increasingly difficult for OEMs to maintain comfortable margins. It is therefore advantageous to encourage customer loyalty, which can maintain or increase OEM revenues as well as maintain profit margins.

Of particular concern for online monetary transactions, such as providing a conventional incentive program, is the potential for abuse or fraud. Two types of abuse or fraud can hinder the effectiveness of such transactions and incentive programs. First, fraudulent ad costs can be incurred by participating advertisers. In one conventional ad program, the program charges the advertiser for each click on an advertiser's ad. Thus, to inflict financial pain on an advertiser, a competitor may deliberately cause additional clicks for that competitor's advertisement. Some competitors or other unscrupulous persons may go so far as to create “automated click robots”. Second, fraudulent user points can be incurred or otherwise awarded to users or customers. Since there is an incentive for the user to follow-through on a particular advertiser's links and ads, it is possible for this incentive to become subject to abuse as well.

Therefore, a need exists for printing incentive and other incentive methods and systems.

There is also a need for printing incentive and other incentive methods and systems which can minimize abuse or fraud.

### SUMMARY OF THE INVENTION

Some or all of the above needs can be addressed by some or all of the embodiments described herein. According to one embodiment of the invention, a method of providing electronic advertising content to a printing customer by dynamically matching user information to advertisers is provided. The method can result in incentives to the customer, including lower printer supplies cost. This method can provide an ad or ad content during a print job since the user is at the client device when the print job is initiated and may be receptive to engaging in a productive activity while the job is printing. The method can also be implemented with a printer to enable printer usage monitoring and to minimize opportunities for fraudulent actions that would cause pain to the advertiser or artificial gain to the user. Embodiments of the invention can permit an OEM to lower supplies cost to the customer through an advertising revenue stream that directly benefits the user. This revenue can result in reduced cost to the customer for future printing supplies, and can provide an additional revenue stream to the OEM. Embodiments of the invention can also provide a revenue stream to the OEM for those customers that choose not to purchase OEM supplies. In other embodiments, other incentive systems and methods, such as providing an incentive for watching, viewing, or interacting with a television or other electronic device, can be implemented.

One embodiment of the invention can provide a method of providing advertising content to a customer. The method can include receiving information associated with a customer. In addition, the method can include receiving information associated with at least one advertiser. Furthermore, the method can include associating at least one keyword with the at least one advertiser. Moreover, the method can include comparing the at least one keyword to a portion of information associated with the customer. Further, the method can include outputting advertising content to the customer based at least in part on the comparison.

In one aspect of this embodiment, the customer is associated with at least one printing device.

In another aspect of this embodiment, the information associated with a customer comprises at least one of the following: a name, an address, a phone number, a zip code, an Internet protocol (IP) address, user interests, user profile information, user identification information, printing frequency information, printing supply or other consumable usage information, or printing device information.

In yet another aspect of this embodiment, the information associated with at least one advertiser comprises at least one of the following: a name, an address, a phone number, a zip code, an Internet protocol (IP) address, products offered by the advertiser, services offered by the advertiser, types of consumers the advertiser is interested in, advertiser profile information, advertiser identification information, demographic information, or a keyword.

In yet another aspect of this embodiment, the at least one keyword comprises at least one of the following: a customer interest, a place, a hobby, a sport, an activity, a color, an object, a brand name.

In yet another aspect of this embodiment, the advertising content comprises at least one of the following: a new window, a video ad, an audio ad, a website, a webpage, a link to a website or webpage, an e-mail, a message, a voice mail, a fax, alphanumeric text advertising a product or service.

In yet another aspect of this embodiment, the method can further include outputting advertising content to the customer is initiated by the receipt of an indication associated with a print-related event.

In yet another aspect of this embodiment, the print-related event comprises at least one of the following: selecting a print command, printing on a printer device, transmitting a document to a printer for printing, transmitting a document to a third-party for printing, scanning a document, reading or receiving an image from a memory card, reading or receiving a document from a memory card, reading or receiving an image from a camera, reading or receiving an image from a mobile communication device, a printer supplies intervention, or a printer power or reset (POR) command.

In yet another aspect of this embodiment, the method can include determining a benefit to provide to the printer consumer based at least in part on the information associated with the printer customer.

In yet another aspect of this embodiment, the benefit comprises at least one of the following: at least one point in a reward program, a monetary amount, a coupon, a discount, a product, or a service.

In yet another aspect of this embodiment, the method can include receiving an indication associated with at least one selection of advertising content by the customer, and based at least in part on the selection, determining an additional benefit to provide to the printer customer.

In yet another aspect of this embodiment, the at least one selection of advertising content by the customer comprises at least one of the following: closing a window associated with the advertising content, clicking on the advertising content, submitting data in response to the advertising content, or making a purchase in response to the advertising content.

In yet another aspect of this embodiment, the additional benefit comprises at least one of the following: at least one point in a reward program, a monetary amount, a coupon, a discount, a product, a service.

According to another embodiment of the invention, a system for providing advertising content to a customer can be provided. The system can include an ad match engine adapted to receive information associated with a customer. In addition, the engine can be adapted to receive information associated with at least one advertiser. Furthermore, the engine can be adapted to associate at least one keyword with the at least one advertiser. Moreover, the engine can be adapted to compare the at least one keyword to a portion of information associated with the customer. Further, the engine can be adapted to output advertising content to the customer based at least in part on the comparison.

According to another embodiment of the invention, a method of providing advertising content to a customer can be provided. The method can include receiving information associated with a customer. In addition, the method can include receiving an indication associated with a print-related event. Furthermore, the method can include outputting advertising content to the customer based at least in part on at least a portion of the information associated with the customer.

In yet another aspect of this embodiment, the customer is associated with at least one printing device.

In yet another aspect of this embodiment, the information associated with a customer comprises at least one of the following: a name, an address, a phone number, a zip code, an Internet protocol (IP) address, user interests, user profile information, user identification information, printing frequency information, printing supply or other consumable usage information, or printing device information.

In yet another aspect of this embodiment, the print-related event comprises at least one of the following: selecting a print command, printing on a printer device, transmitting a document to a printer for printing, transmitting a document to a third-party for printing, scanning a document, reading or receiving an image from a memory card, reading or receiving a document from a memory card, reading or receiving an image from a camera, reading or receiving an image from a mobile communication device, a printer supplies intervention, or a printer power or reset (POR) command.

In yet another aspect of this embodiment, the advertising content comprises at least one of the following: a new window, a video ad, an audio ad, a website, a webpage, a link to a website or webpage, an e-mail, a message, a voice mail, a fax, alphanumeric text advertising a product or service.

In yet another aspect of this embodiment, the at least a portion of the advertising content is selected based in part on at least one keyword.

In yet another aspect of this embodiment, the at least one keyword comprises at least one of the following: a customer interest, a place, a hobby, a sport, an activity, a color, an object, a brand name.

According to another embodiment of the invention, a system for providing advertising content to a customer can be provided. An ad match engine can be adapted to receive information associated with a customer. In addition, the engine can be adapted to receive an indication associated with a print-related event. Furthermore, the engine can be adapted to output advertising content to the customer based at least in part on at least a portion of the information associated with the customer.

According to another embodiment of the invention, a method of providing an incentive for a printer customer can be provided. The method can include outputting advertising content to a printer customer. In addition, the method can include receiving an indication associated with at least one selection of advertising content by the printer customer. Furthermore, the method can include determining a benefit to provide to the printer customer based at least in part on the selection.

In one aspect of this embodiment, the advertising content comprises at least one of the following: a new window, a video ad, an audio ad, a website, a webpage, a link to a website or webpage, an e-mail, a message, a voice mail, a fax, or alphanumeric text advertising a product or service.

In yet another aspect of this embodiment, the at least a portion of the advertising content is selected based in part on at least one keyword.

In yet another aspect of this embodiment, the at least one keyword comprises at least one of the following: a consumer interest, a place, a hobby, a sport, an activity, a color, an object, or a brand name.

In yet another aspect of this embodiment, the printer customer is associated with at least one printing device.

In yet another aspect of this embodiment, the at least one selection of advertising content by the printer customer comprises at least one of the following: closing a window associated with the advertising content, clicking on the advertising content, submitting data in response to the advertising content, or making a purchase in response to the advertising content.

In yet another aspect of this embodiment, the method can include receiving information associated with the printer customer, and based at least in part on the information associated with the printer customer, determining an additional benefit to provide to the printer customer.

In yet another aspect of this embodiment, the information associated with a customer comprises at least one of the following: a name, an address, a phone number, a zip code, an Internet protocol (IP) address, user interests, user profile information, user identification information, printing frequency information, printing supply or other consumable usage information, or printing device information.

In yet another aspect of this embodiment, outputting advertising content to a printer customer is initiated by a print-related event.

In yet another aspect of this embodiment, the print-related event comprises at least one of the following: selecting a print command, printing on a printer device, transmitting a document to a printer for printing, or transmitting a document to a third-party for printing, scanning a document, reading or receiving an image from a memory card, reading or receiving a document from a memory card, reading or receiving an image from a camera, reading or receiving an image from a mobile communication device, a printer supplies intervention, or a printer power or reset (POR) command.

In yet another aspect of this embodiment, the benefit comprises at least one of the following: at least one point in a reward program, a monetary amount, a coupon, a discount, a product, or a service.

According to another embodiment of the invention, a system for providing an incentive for a printer customer can be provided. An ad match engine can be adapted output advertising content to a printer customer. In addition, the engine can be adapted to receive an indication associated with at least one selection of advertising content by the printer customer. Furthermore, the engine can be adapted to determine a benefit to provide to the printer customer based at least in part on the selection.

According to yet another embodiment of the invention, a method of determining an advertising cost for an advertiser can be provided. The method can include outputting advertising content to a printer customer. In addition, the method can include receiving an indication associated with at least one selection of advertising content by the printer customer. Furthermore, the method can include determining a cost to charge to the advertiser based at least in part on the selection.

In one aspect of this embodiment, the advertising content comprises at least one of the following: a new window, a video ad, an audio ad, a website, a webpage, a link to a website or webpage, an e-mail, a message, a voice mail, a fax, or alphanumeric text advertising a product or service.

In yet another aspect of this embodiment, the at least a portion of the advertising content is selected based in part on at least one keyword.

In yet another aspect of this embodiment, the at least one keyword comprises at least one of the following: a customer interest, a place, a hobby, a sport, an activity, a color, an object, or a brand name.

In yet another aspect of this embodiment, the printer customer is associated with at least one printing device.

In yet another aspect of this embodiment, the at least one selection of advertising content by the printer customer comprises at least one of the following: closing a window associated with the advertising content, clicking on the advertising content, submitting data in response to the advertising content, or making a purchase in response to the advertising content.

In yet another aspect of this embodiment, outputting advertising content to a printer customer is initiated by a print-related event.

In yet another aspect of this embodiment, the print-related event comprises at least one of the following: selecting a print command, printing on a printer device, transmitting a document to a printer for printing, transmitting a document to a third-party for printing, scanning a document, reading or receiving an image from a memory card, reading or receiving a document from a memory card, reading or receiving an image from a camera, reading or receiving an image from a mobile communication device a printer supplies intervention, or a printer power or reset (POR) command.

In yet another aspect of this embodiment, the cost comprises at least one of the following: at least one point in an ad cost program, a monetary amount, a coupon, a discount, a product, or a service.

In another embodiment of the invention, a system for determining an advertising cost for an advertiser can be provided. The system can include an ad match engine adapted to output advertising content to a printer customer. In addition, the engine can be adapted to receive an indication associated with at least one selection of advertising content by the printer customer. Furthermore, the engine can be adapted to determine a cost to charge to the advertiser based at least in part on the selection.

In yet another embodiment of the invention, a method of verifying a user input can be provided. The method can include receiving information associated with a customer. In addition, the method can include receiving information associated with a printing device associated with the customer. Furthermore, the method can include receiving information associated with a printing driver associated with a client device. Moreover, the method can include receiving an indication associated with a print-related event. Further, the method can include comparing at least a portion of the information associated with the customer with at least a portion of the information associated with at least one of the printing device associated with the customer or the printing driver associated with a client device. In addition, the method can include determining whether the indication associated with a print-related event is valid based at least in part on the comparison.

In one aspect of this embodiment, the information associated with a customer comprises at least one of the following: a name, an address, a phone number, a zip code, an Internet protocol (IP) address, user interests, user profile information, user identification information, printing frequency information, printing supply or other consumable usage information, or printing device information.

In yet another aspect of this embodiment, the information associated with a printing device comprises at least one of following: information associated with an ASIC,

In yet another aspect of this embodiment, information associated with a printing driver comprises at least one of following: information associated with a client device in communication with the printing device.

In yet another aspect of this embodiment, the print-related event comprises at least one of the following: selecting a print command, printing on a printer device, transmitting a document to a printer for printing, or transmitting a document to a third-party for printing, scanning a document, reading or receiving an image from a memory card, reading or receiving a document from a memory card, reading or receiving an image from a camera, reading or receiving an image from a mobile communication device, a printer supplies intervention, or a printer power or reset (POR) command.

In yet another aspect of this embodiment, the advertising content comprises at least one of the following: a new window, a video ad, an audio ad, a website, a webpage, a link to a website or webpage, an e-mail, a message, a voice mail, a fax, or alphanumeric text advertising a product or service.

In another embodiment of the invention, a system for verifying a user input can be provided. The system can include an ad match engine adapted to receive information associated with a customer. In addition, the engine can be adapted to receive information associated with a printing device associated with the customer. Furthermore, the engine can be adapted to receive information associated with a printing driver associated with a client device. Moreover, the engine can be adapted to receive an indication associated with a print-related event. Further, the engine can be adapted to compare at least a portion of the information associated with the customer with at least a portion of the information associated with at least one of the printing device associated with the customer or the printing driver associated with a client device. In addition, the engine can be adapted to determine whether the indication associated with a print-related event is valid based at least in part on the comparison.

Yet another embodiment of the invention can include a method for providing advertising content to a printer customer. The method can include receiving an indication associated with an advertising ink cartridge. In addition, the method can include receiving information associated with a printer customer. Furthermore, the method can include outputting ad content based at least in part on the information associated with the printer customer.

In one aspect of this embodiment, receiving an indication associated with an ink cartridge comprises detecting an advertising ink cartridge.

In another aspect of the embodiment, the ink cartridge is adapted to provide ad printing instructions to a printhead associated with an output device.

In another aspect of the embodiment, receiving information associated with a printer customer comprises prompting the printer customer to enter personal information.

In another aspect of the embodiment, the method can include receiving information associated with at least one advertiser, and comparing the information associated with a printer customer with information associated with at least one advertiser.

In yet another aspect of the embodiment, outputting ad content based at least in part on the information associated with the printer customer is initiated when a print job begins.

In yet another aspect of the embodiment, the ad content can be modified by at least one of the following: amount of ads per page; size of ads per page; frequency of ads printed; location of ads on a page; or frequency of ads per number of pages.

In yet another embodiment of the invention, a system for providing advertising content to a printer customer can be provided. The system can include a processor adapted to receive an indication associated with an advertising ink cartridge. The processor can be further adapted to receive information associated with a printer customer. Furthermore, the processor can be adapted to output ad content based at least in part on the information associated with the printer customer.

In yet another embodiment of the invention, an apparatus for providing advertising content to a printer customer can be provided. The apparatus can include an advertising ink cartridge adapted to facilitate transmission of an indication to a processor, wherein the engine obtains information associated with a printer customer. Furthermore, the advertising ink cartridge can be adapted to output ad content based at least in part on the information associated with the printer customer.

Other systems and processes according to various embodiments of the invention will become apparent with respect to the remainder of this document.

### BRIEF DESCRIPTION OF THE DRAWINGS

Having thus described the invention in general terms, reference will now be made to the accompanying drawings, which are not necessarily drawn to scale, and wherein:

FIG. 1 shows an example system for providing a printing incentive or incentive program according to an illustrative embodiment of the invention.

FIG. 2 shows an example method for providing a printing incentive or incentive program according to an illustrative embodiment of the invention.

FIG. 3 shows another example method for providing a printing incentive or incentive program according to an illustrative embodiment of the invention.

FIG. 4 shows another example method for providing a printing incentive or incentive program according to an illustrative embodiment of the invention.

FIG. 5 shows another example method for providing a printing incentive or incentive program according to an illustrative embodiment of the invention.

FIGS. 6 and 7 illustrate example ads or ad content provided by a printing incentive method or incentive program according to an illustrative embodiment of the invention.

### DETAILED DESCRIPTION OF EMBODIMENTS OF THE INVENTION

Embodiments of the invention now will be described more fully hereinafter with reference to the accompanying drawings. Indeed, these inventions may be embodied in many different forms and should not be construed as limited to the embodiments set forth herein; rather, these embodiments are provided so that this disclosure will satisfy applicable legal requirements. Like numbers refer to like elements throughout.

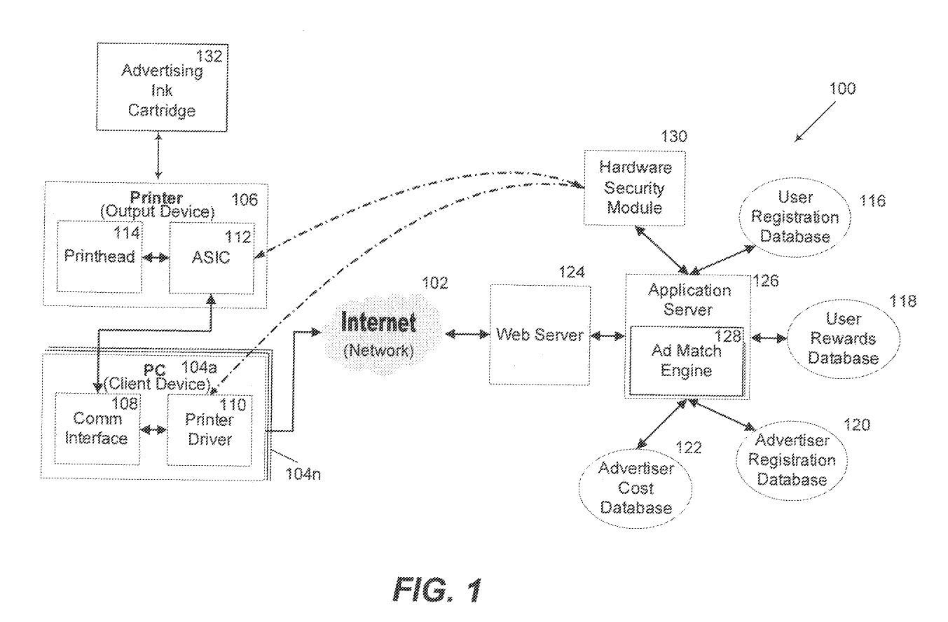

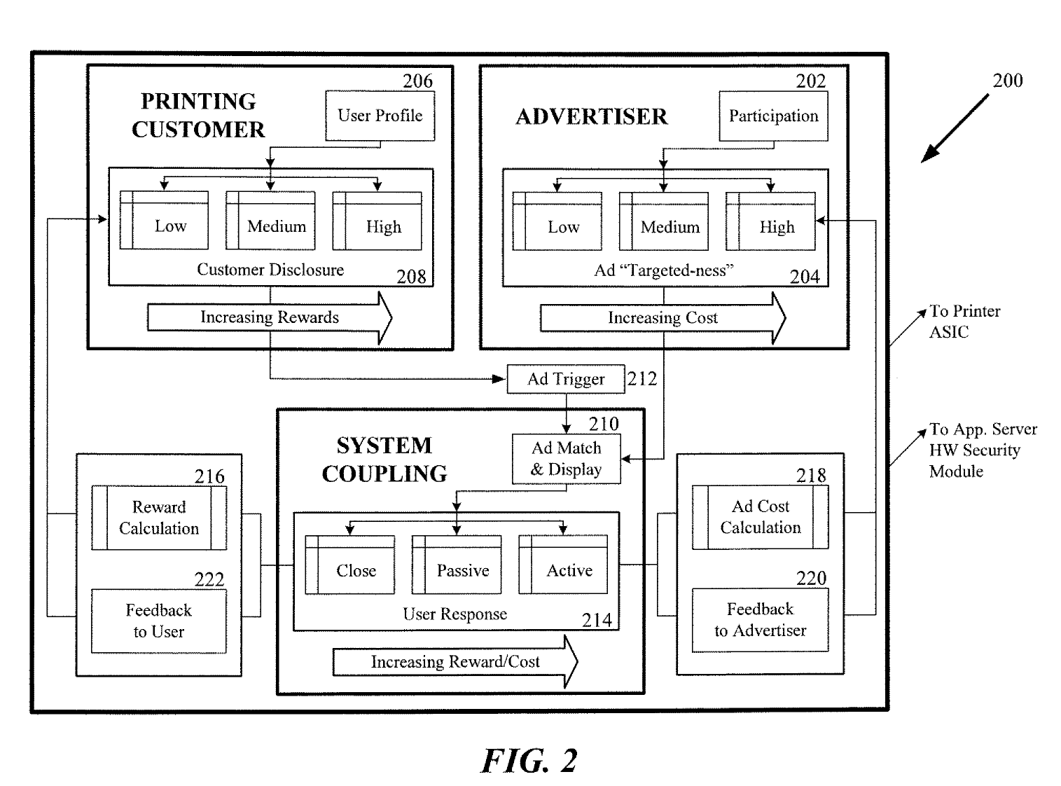

FIG. 1 illustrates an example system 100 and associated architecture for providing printing incentives in accordance with an embodiment of the invention. In one example, the system 100 can implement a printing incentive method, such as 200 shown and described with respect to FIG. 2. In another example, the system 100 can implement some or all of the processes, techniques, and methodologies described with respect to FIGS. 2-4.

The system 100 is shown with a communications network 102, such as the Internet, in communication with at least one client device 104a. Any number of other client devices 104n can also be in communication with the network 102. The network 102 is also shown in communication with at least one output device 106, such as a printer. In this embodiment, at least one of the client devices 104a can be associated with an output device 106, such as a printer for performing a print-related event and for providing a print output to a print customer.

The communications network 102 shown in FIG. 1 can be, for example, the Internet. In another embodiment, the network 102 can be a wireless communications network capable of transmitting both voice and data signals, including image data signals or multimedia signals. Other types of communications networks, including local area networks (LAN), wide area networks (WAN), or public switched telephone network can be used in accordance with various embodiments of the invention.

Each client device 104a-n can be a computer or processor-based device capable of communicating with the communications network 102 via a signal, such as a wireless frequency signal or a direct wired communication signal. A respective communication interface 108 associated with each client device 104a-n can facilitate communications between the client device 104a-n and output device 106 or printer, and between the client device 104a-n and network 102 or Internet. Each client device, such as 104a, can include a processor and a computer-readable medium, such as a random access memory (RAM), coupled to the processor. The processor can execute computer-executable program instructions stored in memory. Computer executable program instructions stored in memory can include a printer driver application program, or printer driver engine or module, such as 110 The printer driver engine or module can be adapted to implement a set of instructions adapted to convert data to a suitable format for printing by a printer, such as output device 106.

An output device 106 or printer can include a processor, such as an ASIC 112, and a computer-readable medium, such as a random access memory (RAM), coupled to the processor or ASIC 112, and a printhead 114. The processor or ASIC 112 can execute computer-executable program instructions stored in a memory. Computer executable program instructions stored in memory can include printing instructions or other instructions adapted to provide a printed document or perform a print-related event. An output device 106 or printer can be adapted to perform a print-related event and provide a print output to a print customer. In one embodiment, the output device 106 or printer can receive a signal from the printer driver engine 110 associated with the client device 104a, and can utilize the printhead 114 to output a printed document.

Suitable processors for a client device 104a-n and output device 106 or printer may comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor or ASIC 112, with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Client devices 104a-n may also comprise a number of other external or internal devices such as a mouse, a CD-ROM, DVD, a keyboard, a display, or other input or output devices. As shown in FIG. 1, a client device such as 104a can be in communication with an output device via a communication interface, such as 108. Examples of client devices 104a-n are personal computers, mobile computers, handheld portable computers, digital assistants, personal digital assistants, cellular phones, mobile phones, smart phones, pagers, digital tablets, desktop computers, laptop computers, Internet appliances, and other processor-based devices. In general, a client device, such as 104a, may be any type of processor-based platform that is connected to a network, such as 102, and that interacts with one or more application programs. Client devices 104a-n may operate on any operating system capable of supporting a browser or browser-enabled application, such as Microsoft® Windows® or Linux. The client devices 104a-n shown include, for example, personal computers executing a browser application program such as Microsoft Corporation's Internet Explorer™, Netscape Communication Corporation's Netscape Navigator™, and Apple Computer, Inc.'s Safari™.

In one embodiment, suitable client devices can be standard desktop personal computers with Intel x86 processor architecture, operating a Microsoft® Windows® operating system, and programmed using a Java language.

A user, such as a print customer, can interact with a client device, such as 104a, via an input device (not shown) such as a keyboard or a mouse. For example, a user can input information, such as identification data associated with the user, printer identification data associated with a printer or other output device, or other information associated with the user, output device or printer, via the client device 104a. In another example, a user can input user identification and print-related information via the client device 104a by keying text via a keyboard or inputting a command via a mouse. Other information associated with a user, such as a print customer, can be collected, gathered, or otherwise transmitted by a client device, such as 104a, for storage and processing. Examples of this type of information can include, but are not limited to, printing frequency information, printing supply or other consumable usage information, and printing device information. Printing supply or consumables can include, but are not limited to, paper, ink, toner, or other supplies used by a printer or related device.

Memory, such as described above, or another data storage device, can store information associated with user identification or print-related information for subsequent retrieval. In this manner, the system 100 can store user identification and print-related information in memory (not shown) associated with a client device, such as 104a or a desktop computer, or a database, such as 116-122, in communication with a client device 104a or a desktop computer, and a network, such as 102.

The memory and databases 116-122 can be in communication with other databases, such as a centralized database, or other types of data storage devices. When needed, data stored in the memory or databases 116-122 may be transmitted to a centralized database capable of receiving data, information, or data records from more than one database or other data storage devices. The databases shown in FIG. 1 include, but are not limited to, a user registration database 116, a user rewards database 118, an advertiser database 120, and an advertiser cost database 122. In other embodiments, some or all of the databases can be integrated into a fewer number of databases or data storage devices, or may be distributed across a greater number of databases or data storage devices.

The system 100 can display user or print-related information via an output device associated with a client device 104a-n. In one embodiment, user and print-related information can be displayed on an output device, such as a display (not shown), associated with a remotely located client device, such as 104a. Suitable types of output devices can include, but are not limited to, private-type displays, public-type displays, plasma displays, LCD displays, touch screen devices, and projector displays on cinema-type screens.

The system 100 can also include a web server 124 and application server 126 in communication with the network 102. In the embodiment shown, the web server can be in communication with the network 102, or Internet. In one embodiment, the web server may be in communication with another type of network, such as a public switched telephone network. In another embodiment, the web server 124 and application server 126 can be a single integrated server device. In the embodiment shown, the application server 126 is in communication with the web server 124, and can ultimately communicate with the network 102, or Internet.

Similar to the client devices 104a-n, the web server 124 and application server 126 shown can each comprise a processor coupled to a computer-readable memory. In the embodiment shown, an ad match engine 128 or module can be stored in memory (not shown) associated with the application server 126. Furthermore, the ad match engine 128 or module can interface with a hardware security module 130, which may be a separate module or set of computer-executable instructions operating on another processor-based device, or may be an integrated module stored in memory associated with the application server 126. The server device 126 can also be in communication with one or more databases, such as 116-122, or other data storage device. One or more of the databases 116-122 can receive and store data from the application server 126, or from a client device, such as 104a, via the network 102. Data stored in one or more of the databases 116-122 can be retrieved by the application server 126 or client devices 104a-n as needed.

The application server 126, via the web server 124, can transmit and receive information to and from multiple sources via the network 102, including a client device such as 104a, and database such as 118 or other data storage device.

Application server 126, depicted as a single computer system, may be implemented as a network of computer processors. Examples of suitable application server device 126 are servers, mainframe computers, networked computers, a processor-based device, and similar types of systems and devices. Associated client processors and the server processors can be any of a number of computer processors, such as processors from Intel Corporation of Santa Clara, Calif. and Motorola Corporation of Schaumburg, Ill. The computational tasks associated with rendering a graphical image could be performed on the server device(s) and/or some or all of the client device(s).

In one embodiment, computer executable program instructions stored in an memory of the application server can include an ad match engine or module, or ad match application program. The ad match engine or module, or ad match application program can be adapted to implement a method for providing printing incentives. In addition, an ad match engine or module can be adapted to receive one or more signals from one or more users, print customers, advertisers, reward program administrators, printer equipment manufacturer, or printing supplies provider. In one embodiment, the ad match engine can interface with or otherwise include a hardware security module. In another embodiment, an ad match engine can communicate with various user and advertiser databases or associated data storage devices. Other examples of functionality and aspects of embodiments of an ad match engine or module, or ad match application program are described below.

One embodiment of an ad match engine or module can include a main application program process with multiple threads. Another embodiment of an ad match engine or module can include different functional modules. An example of one programming thread or functional module can be a module for communicating with an advertiser. Another programming thread or module can be a module for communicating with a printer equipment manufacturer, such as an OEM. Another programming thread or module can be a module for communicating with a printing supplies provider. Yet another programming thread or module can provide communications and exchange of data between multiple advertisers and multiple printer customers. One other programming thread or module can provide database management functionality, including storing, searching, and retrieving data, information, or data records from a combination of databases, data storage devices, and one or more associated servers.

In one embodiment schematically depicted in FIG. 1, an ad match engine such as 128 can be stored in memory associated with the application server 126. The ad match engine 128 can communicate via the network 102 with the ASIC 112 associated with the output device or printer 106 and the printer driver 110 associated with the client device 104a-n. A hardware security module such as 130 can interface with the ad match engine 128, and can facilitate communications between the application server 126 and the client devices 104a-n, and the application server 126 and output device or printer 106.

In another embodiment of the invention, an advertising ink cartridge, such as 132, can be implemented with an output device, such as printer 106. An advertising ink cartridge 132 can be a type of ink cartridge that provides both printing functionality and advertising functionality, such as a printing incentive method. In one embodiment, an advertising ink cartridge 132 can be adapted to facilitate transmission of an indication to an ad match engine, such as 128, wherein the engine obtains information associated with a printer customer. Furthermore, the advertising ink cartridge 132 can be adapted to output ad content based at least in part on the information associated with the printer customer.

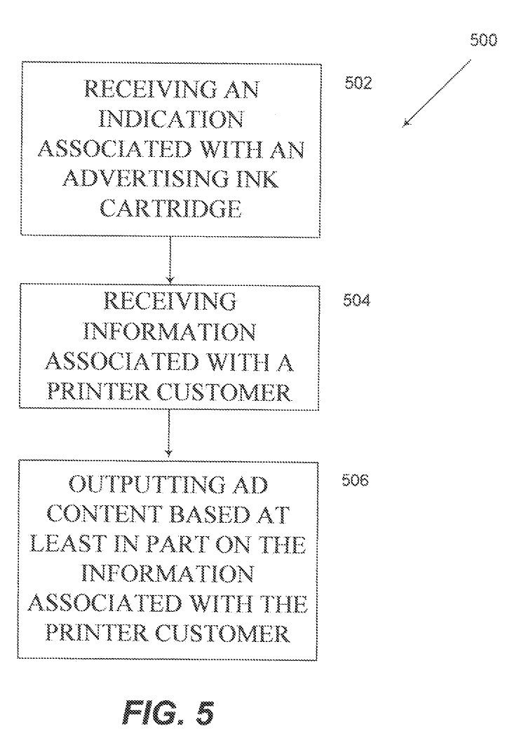

For example, an advertising ink cartridge such as 132 can be mounted to an output device, such as printer 106. An ASIC, such as 112, processor, or other memory associated with the printer 106 can detect or otherwise receive an indication from the advertising ink cartridge 132 that the ink cartridge is adapted for both printing functionality and advertising functionality. In this example, the ASIC 112 can store a set of computer-executable instructions for gathering information from a user or customer, and directing one or more ads or ad content to the user or customer based at least in part on the information received from the user or customer. Ads or ad content can be dynamically generated by an ad match engine, such as 128, or otherwise obtained from a third party, or database, such as 122, via a network, such as the Internet 102. If no information is received from the user or customer in response to one or more prompts directed to the user or customer, the ASIC 112 can direct previously stored ads or ad content to the user or customer. In any instance, ads or ad content can be output to the user or customer via a suitable output device such as a display associated with a client device, such as 104a-n. Various methods associated with an advertising ink cartridge are described below in FIG. 5.

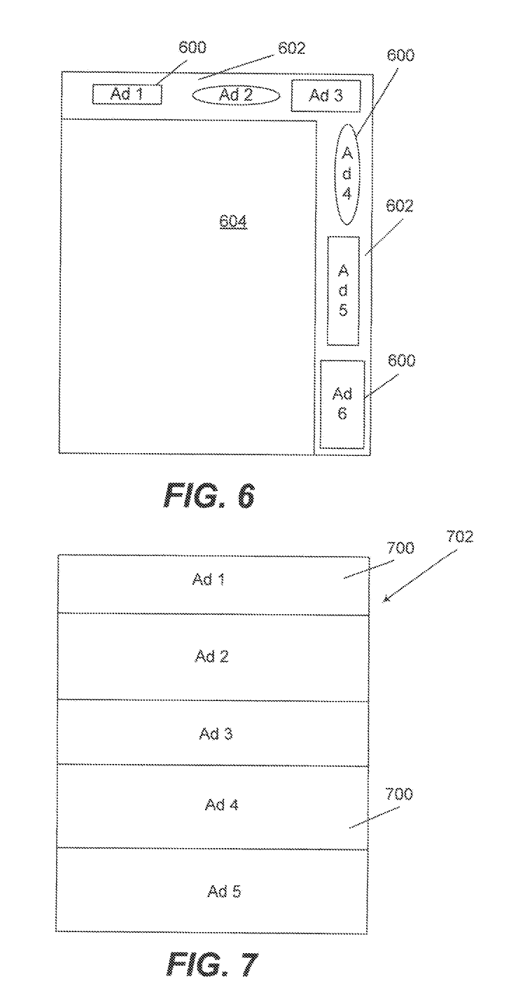

In one embodiment, an advertising ink cartridge can be adapted to facilitate transmission of an indication to an ad match engine, or to an ASIC such as 112, to modify the level of ads or ad content associated with the advertising ink cartridge. For example, the advertising ink cartridge can be adapted to set the values of one or more bits associated with the ASIC 112 to correspond with different levels of ads or ad content. In one example, one or more bits can be set in an ASIC 112 to provide for scaled images associated with ad or ad content to fit within a predefined border on a single page document output from an output device, such as printer 106. The scaled images associated with the ad or ad content could be printed within the predefined border and within a printable area for a particular paper size. An example of scaled images printed within a predefined border is further described below in FIG. 6. In another example, one or more bits can be set in an ASIC 112 to provide for printing ads or ad content on every “nth” page. Alternatively, ads or ad content could be printed on the first and/or last page of every print job. In this manner, coupons or coupon-type ads could be effectively targeted to a user or customer. An example of ads or ad content printed on every “nth” page, or on the first and/or last page of a print job is further described below in FIG. 7.

In one embodiment, an ASIC such as 112 can include one or more default-type ads or ad content stored in memory. For example, a default-type ad or ad content can be generated in a relatively low resolution bitmap format and stored in a JPEG file format. When a client device, such as 104a-n, and associated output device, such as printer 106, have not yet been connected to a network, such as the Internet 102, and communications with an application server or ad match engine have not yet been facilitated, the default-type ads or ad content can be output by the ASIC 112 when an advertising ink cartridge, such as 132, is in use by a user or customer. After the client device 104a and printer 106 have been in communication with an application server 126 or ad match engine 128, additional ads or ad content can be obtained from a third party, database such as 120, or data storage device. Such additional ads or ad content can be matched with particular users or customers, and subsequently output to the users or customers when the advertising ink cartridge 132 or other similar type of ink cartridge is in use.

One skilled in the art may recognize the applicability of embodiments of the invention to other environments, contexts, and applications. For instance, in one embodiment, a system and method for providing incentives for watching, viewing, or interacting with a television or other electronic device can be provided. A system similar to FIG. 1 can be implemented, wherein the client device 104a-n and associated output device 106 or printer can be replaced with a television or other electronic device or devices capable of communicating with an ad match engine or module, such as 128, via a communication network, such as 102. In such a system configuration, the ad match engine or module can be adapted to implement a method for providing television watching, viewing, or interaction incentives. In addition, an ad match engine or module could be adapted to receive one or more signals from one or more users, television or electronic device customers, advertisers, reward program administrators, television or electronic device or equipment manufacturers, or other television or electronic device support entities. an advertising ink cartridge such as 132 can be mounted to an output device, such as printer 106. A processor or other memory associated with the television or electronic device may gather information from a user or customer, and direct one or more ads or ad content to the user or customer based at least in part on the information received from the user or customer. Ads or ad content can be dynamically generated by an ad match engine or module, such as 128, or otherwise obtained from a third party, or database, such as 122, via a network, such as 102. If no information is received from the user or customer in response to one or more prompts directed to the user or customer, the processor or other memory may direct previously stored ads or ad content to the user or customer. In any instance, ads or ad content can be output to the user or customer via a suitable output device such as the television or a display associated with the electronic device. Various methods associated with implementing an incentive program for providing television watching, viewing, or interaction incentives can be similar to those described with respect to FIGS. 2-5, or otherwise modified in accordance with an embodiment of the invention. In this manner, an economic incentive can be provided to a customer to voluntarily participate and disclose personal information, and to dynamically match and deliver targeted ads or ad content from an advertiser to one or more selected customers.

FIG. 2 illustrates an example process or method flow for providing a printing incentive or incentive program according to an embodiment of the invention. The system 100 described in FIG. 1 can be used to implement the process or method 200 of FIG. 2. Other embodiments of process flows and methods for providing printing incentives can include fewer or greater numbers of steps, and may include some or all of the steps described in FIG. 2. Arrows in the process or method flow are intended to indicate signal and/or data flow from one functional component block to another, and the order of execution of each numbered functional component block is not necessarily consecutively performed, but rather, the numbered functional component blocks are for the convenient reference to the accompanying description below.

The process or method 200 of FIG. 2 begins at block 202. In block 202, one or advertisers can choose to participate in a printing incentive program. For example, a printer manufacturer can receive an indication from an advertiser to begin participating in a printing incentive program. In this embodiment, an indication can be transmitted to an ad match engine, such as 128 in FIG. 1, where the ad match engine 128 can store a corresponding indication associated with each advertiser's participation in, for example, an advertiser registration database such as 120 or other data storage device. In one embodiment, an ad match engine 128 can offer several participation options to an advertiser. Participation options can include, but are limited to, participation in a user or customer loyalty, incentive, or reward program, participation in providing varying levels of ads or ad content to users or customers, and priority space for ads or ad content provided to users or customers. In any instance, the advertiser registration database 120 can store indications whether a particular advertiser is a participant in a printing incentive or other type of incentive program, and other indications of any participation options selected or desired by the advertisers.

Block 202 is followed by block 204, in which each of the participating advertisers can select criteria for customers to target. In the example shown, an ad match engine, such as 128 in FIG. 1, can prompt a participating advertiser to select criteria for one or more customers to target with an ad. Based at least in part on a relative level of “targetedness” or relevance to information associated with a user profile, the participating advertiser can pay a relatively low, medium, or high payment amount for a targeted ad. Information provided by or selected by an advertiser can include, but is not limited to, a name, an address, a phone number, a zip code, an Internet protocol (IP) address, products offered by the advertiser, services offered by the advertiser, types of consumers the advertiser is interested in, advertiser profile information, advertiser identification information, demographic information, or a keyword. A keyword can include, but is not limited to, a customer interest, a place, a hobby, a sport, an activity, a color, an object, or a brand name. In one embodiment, an ad auction or other sales or distribution methods or devices can be used to apportion certain ads, keywords, or ad time to a participating advertiser. Advertising revenue resulting from any such methods, including association with a user profile, can be directed to an OEM provider, a customer, or both. In another embodiment, participating advertisers can pay for or purchase particular keywords. Each keyword can be assigned a payment amount depending on the frequency of use, popularity of the keyword with one or more consumers, or frequency the keyword appears in one or more user profiles. In any instance, advertiser criteria, advertiser payments, and other target-related information associated with participating advertisers can be stored by the ad match engine 128 in a database such as the advertiser registration database 120 or other data storage device.

Another portion of the process or method 200 continues at block 206, in which a user profile is created for a customer. In this embodiment, a customer communicates with an ad match engine, such as 128 in FIG. 1, via a network, such as 102 or the Internet. For example, a customer may purchase a new output device or printer, such as 106 in FIG. 1, or may observe or view an advertisement. In any instance, the customer can be directed to a network address, link, or other location to facilitate communication with an ad match engine, such as 128. The ad match engine 128 can facilitate entry of personal information associated with the customer into a user profile. Personal information can include, but is not limited to, a name, address, phone number, a zip code, an Internet protocol (IP) address, user interests, user profile information, user identification information, printing frequency information, printing device information, e-mail address, hobby information, interest information, hardware and peripheral information, supply or other consumable usage information, printer type, and other personal or user identification information. In one embodiment, an ad match engine can prompt a customer to make a decision to participate in a printing incentive program. If the customer decides to participate, the ad match engine can continue by prompting the customer to enter his or her personal information.

Block 206 is followed by block 208, in which customer-entered personal information is received. In the embodiment shown, an ad match engine such as 128 can prompt the customer to enter progressively increasing amounts of personal information. In this example, a customer can decide to enter a relatively low, medium, or high amount of personal information. In most instances, the customer dictates the relative amount of personal information to provide to the ad match engine. In any instance, the ad match engine 128 can receive the personal information from the customer and can store the information in a database, such as a user registration database 116 or other data storage device.

In one embodiment, a customer can be prompted by an ad match engine or other module associated with an application server, such as 126 in FIG. 1, to participate in a subsidized photo printing business model and system.

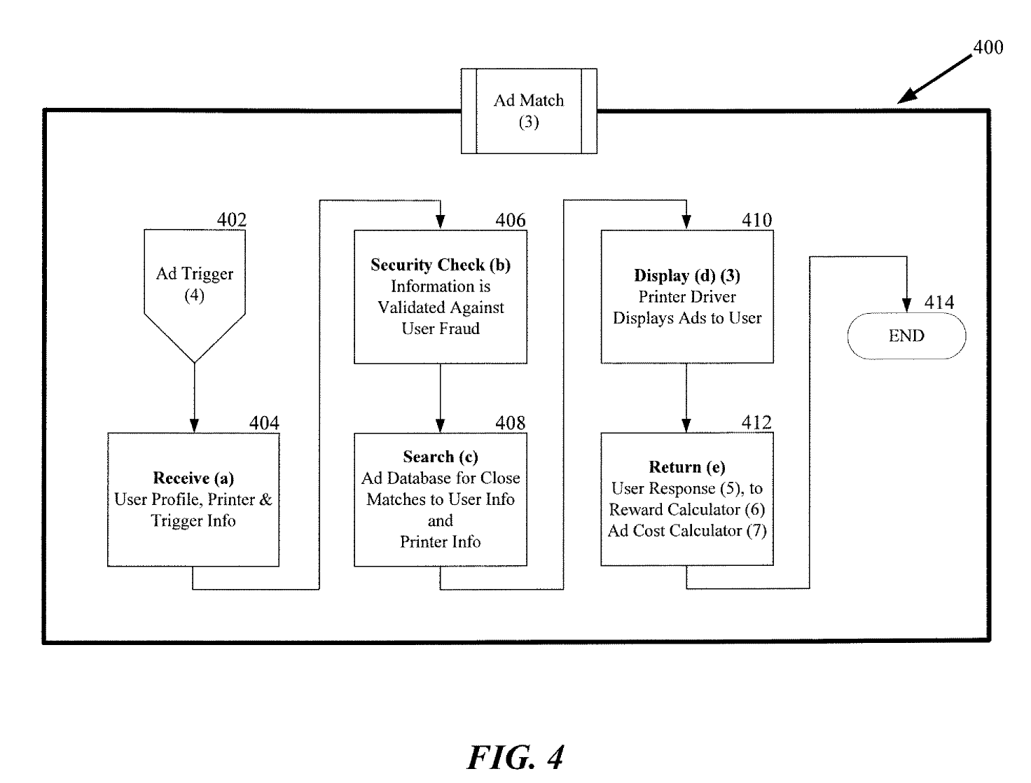

The method 200 continues at block 210, in which at least a portion of user profile information is compared to advertiser criteria. For example, an ad match engine, such as 128 in FIG. 1, can compare customer interest and hobby information stored in a user registration database, such as 116, with participating advertiser criteria stored in an advertiser registration database, such as 120. Other comparisons between information stored in a user registration database 116 and the advertiser registration database 120 can be performed. An example of comparing and matching a user profile to advertiser criteria is described in greater detail below in FIG. 4.

The method 200 continues at block 212, in which a printing event triggers an ad to be output to a customer. In this embodiment, an ad match engine such as 128 can detect or otherwise receive a signal associated with a printing event. A printing event can include, but is not limited to, a signal associated with printing a document using an output device such as a printer 106, a signal associated with a print command input to a client device such as 104a-n, a signal associated with a print command communicated from a printer driver, such as 110, to an output device such as printer 106, selecting a print command, printing on a printer device, transmitting a document to a printer for printing, transmitting a document to a third-party for printing, scanning a document, reading or receiving an image from a memory card, reading or receiving a document from a memory card, reading or receiving an image from a camera, reading or receiving an image from a mobile communication device, a printer supplies intervention, a printer POR (power or reset) command. When a signal associated with a printing event is detected or otherwise received, the ad match engine 128 can facilitate the output of an ad or particular ad content to a customer associated with the printing event. For example, when a print job is initiated by a customer entering a print command at a client device, such as 104a, the delay between initiating and completing a print job can be used to output or display an ad or particular ad content on an output device, such as a display, associated with the client device 104a. The ad match engine 128 can retrieve or otherwise facilitate the retrieval of an ad or ad content from one or more advertisers, and can transmit or otherwise facilitate the transmission of the ad or ad content from a database, such as the advertiser registration database 120, to the client device 104a associated with the customer. In some instances, an ad or ad content can be ultimately transmitted by an ad match engine and output to a display associated with a printer 106 or other output device. An ad or ad content can include, but is not limited to, a new window, a video ad, an audio ad, a website, a webpage, a link to a website or webpage, an e-mail, a message, a voice mail, a fax, or alphanumeric text advertising a product or service.

In one embodiment, the printing event trigger is the performance of a “print job.” In comparison to conventional advertising methods wherein the initiation or performance of an Internet or network search results in ads to be selected and charges applied to the advertiser, this embodiment costs the user in the form of printer supplies, in particular, printer ink, toner and/or media. In this manner, this embodiment is a self-limiting means to the user, and is can minimize advertising fraud which can be prevalent with other advertising methods.

In one embodiment, the functions associated with blocks 210 and 212 can be interchanged, or performed simultaneously and in real time depending on the processing speed associated with the system, such as 100, and method 200.

Block 212 is followed by block 214, in which a user response to the ad or ad content is received. In the embodiment shown, an ad match engine such as 128 in FIG. 1 can receive an indication of a user response to an ad or ad content. For example, a customer's response to an ad or ad content can include, but is not limited to, closing the ad or ad content, passively responding to the ad or ad content, or actively responding to the ad or ad content. In any instance, a signal or other indication corresponding to any level of user response can be received by the ad match engine 128, and associated data can be stored by the engine 128 in the user registration database 116 or other data storage device.

Closing the ad or ad content can include clicking on a closing box to remove the ad from the customer's display or output device. If the customer closes the ad or ad content, the ad match engine 128 can remove the ad or ad content from the user's display or output device. The ad match engine 128 can record the act of closing the ad or ad content, and associated data can be stored by the engine 128 in the user registration database 116 or other data storage device.

Passively responding to the ad or ad content can include ignoring the ad or ad content, and taking no action to interact with the ad or ad content. In the instance of a passive-type response, a corresponding signal or indication may instead be the expiration of a timer, receipt of signal or indication corresponding to a client device or output device command or action, or the absence of receipt of any signal or indication corresponding to a user response to an ad or ad content. If a passive-type response is performed by the customer, the ad match engine 128 can leave the ad or ad content on the customer's display or output device. The ad match engine 128 can record that a passive-type user response was received, and associated data can be stored by the engine 128 in the user registration database 116 or other data storage device.

Actively responding to the ad or ad content can include clicking on the ad or ad content, entering an input into a text box, or moving an arrow over the ad or ad content using an input device such as a mouse or indicator. If an active-type response is received by the ad match engine 128, the ad match engine can provide additional ads or ad contents, or can link the customer to additional ads or ad content. The ad match engine 128 can record that an active-type user response was received, and associated data can be stored by the engine 128 in the user registration database 116 or other data storage device.

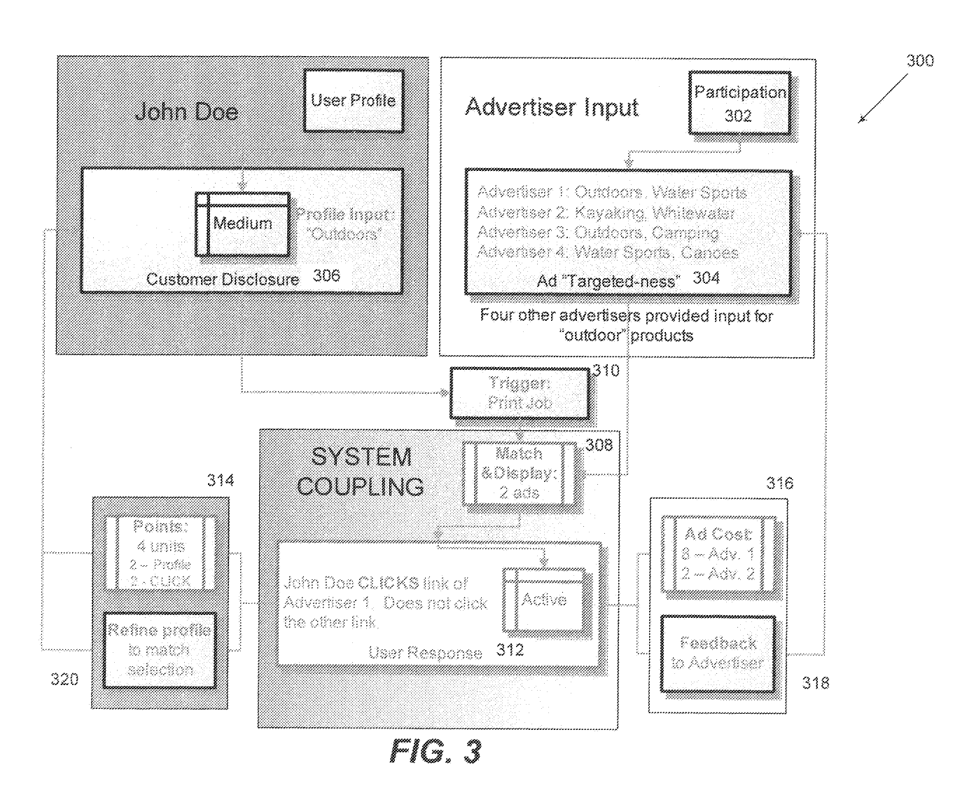

The method 200 continues at block 216, in which a reward or benefit is calculated based at least in part on the user response to an ad or ad content. In the embodiment shown, an ad match engine such as 128 in FIG. 1 can calculate a reward or benefit based at least in part on the user response to an ad or ad content. For example, based at least in part on the user response to an ad or ad content, any number of reward or benefit points can be calculated by the ad match engine 128 and credited to the user's or customer's account. The ad match engine 128 can, for instance, calculate an increasing amount of reward or benefit points for relatively greater amounts of user response to or interaction with an ad or ad content. In the instance that a user closes an ad, a relatively low amount of reward or benefit points, such as 1 point can be credited to a user or customer account. In the instance that a user has a passive-type response such as not responding at all, an intermediate amount of reward or benefit points, such as 3 points can be credited to a user or customer account. In the instance that a user has an active-type response such as clicking on an ad, or inputting text to an ad, a relatively high amount of reward or benefit points, such as 10 points can be credited to a user or customer account. The reward or benefit points can be points accumulated in a loyalty, incentive, or reward program, and can be utilized by the user or customer to purchase or discount the prices of printer supplies, printers, OEM or non-OEM products, supplies, or services. In any instance, the reward or benefit points calculated by the ad match engine 128 can be stored in an account associated with the user or customer, and stored in a user rewards database, such as 118, or other data storage device. A more detailed example of the determination of a reward or benefit is described below with respect to FIG. 3.

In one embodiment, the calculation of reward or benefit points can depend on several factors. Factors can include, but are not limited to, amount of information in a user profile, level of advertiser participation, level of user response to an ad or ad content, and any combination thereof. For example, if a user or customer provides a relatively greater amount of personal information in a user profile, a relatively greater reward, such as greater number of reward or benefit points, can be calculated. In another example, if an advertiser decides to participate in a user rewards or incentive program offered to users or customers, a relatively greater number of reward or benefit points can be calculated. In yet another example, if a user or customer responds with an active-type response rather than a passive-type response, a relatively greater number of reward or benefit points can be calculated.

In one embodiment, a reward or benefit can include other types of rewards or benefits other than points in a reward or loyalty program. Rewards or benefits can include, but are not limited to, incentives, coupons, discounts, preferred pricing, a level, a status level, or any other reward, benefit, or incentive provided to a user or customer in return for a user's response to an ad.

The method 200 continues at block 218, in which an ad cost is determined. In the embodiment shown, an ad match engine such as 128 in FIG. 1 can calculate an ad cost based at least in part on the user or customer response to an ad or ad content. For example, based at least in part on the user response to an ad or ad content, an ad cost can be calculated by the ad match engine 128 and charged to the advertiser's account. The ad match engine 128 can, for instance, calculate an increasing ad cost for relatively greater amounts of user response to or interaction with an ad or ad content associated with the advertiser. An ad cost can include, but is not limited to, at least one point in an ad cost program, a monetary amount, a coupon, a discount, a product, or a service. In the instance that a user closes an ad associated with the advertiser, a relatively low ad cost, such as 1 point can be charged to an advertiser account. In the instance that a user has a passive-type response such as a user or customer not responding at all, an intermediate ad cost, such as 3 points can be charged to an advertiser account. In the instance that a user has an active-type response such as clicking on an ad associated with the advertiser, or inputting text to an ad associated with the advertiser, a relatively high ad cost, such as 10 points can be charged to an advertiser account. The ad cost can be points accumulated in ad match program, and can be utilized by the ad match program host or administrator user or customer to charge advertisers for their participation in the program. In any instance, the ad cost calculated by the ad match engine 128 can be stored in an account associated with the advertiser, and stored in an advertiser cost database, such as 122, or other data storage device. A more detailed example of the determination of an ad cost is described below with respect to FIG. 3.

In one embodiment, the calculation of an ad cost can depend on several factors. Factors can include, but are not limited to, feedback from one or more prior ads or ad content, level of participation by an advertiser, level of matching between a user profile and advertiser-selected criteria or keywords, level of user response to an ad or ad content, and any combination thereof. For example, if a user or customer profile includes personal information that matches the advertiser-selected criteria or keywords, a relatively greater ad cost, such as greater number of ad cost points, can be calculated. In another example, if an advertiser decides to participate in a user rewards or incentive program offered to users or customers, a relatively greater ad cost can be calculated. In yet another example, if a user or customer responds to a particular advertiser's ad or ad content with an active-type response rather than a passive-type response, a relatively greater number of ad cost points can be calculated.

In one embodiment, an ad cost can include other types of costs other than points in an ad match program. Costs can include, but are not limited to, a monetary amount.

The method 200 continues at block 220, in which feedback is provided to an advertiser based at least in part on a user or customer response to an ad or ad content. In the embodiment shown, an ad match engine such as 128 in FIG. 1 can generate and transmit feedback to an advertiser based at least in part on one or more user or customer responses to ads or ad content associated with the advertiser. For example, positive feedback can be provided to an advertiser if an ad or ad content is particularly successful in eliciting an active-type response from a user or customer. Likewise, negative feedback can be provided to an advertiser if an ad or ad content is not particularly successful in eliciting an active-type response, and instead, generates a passive-type response or a response to close an ad from a user or customer. In any instance, feedback generated by the ad match engine 128 can be used by an advertiser to improve the ads or ad content. In addition, feedback generated by the ad match engine 128 can be used by the engine 128 in determining subsequent ad costs for one or more advertisers.

The method 200 continues at block 222, in which feedback is provided to a user or customer based at least in part on a user or customer response to an ad or ad content. In the embodiment shown, an ad match engine such as 128 in FIG. 1 can generate and transmit feedback to a user or customer based at least in part on one or more user or customer responses to ads or ad content. For example, feedback such as a number or reward points earned at a particular time can be provided to a user if the user or customer actively responds to a particular ad or ad content. Likewise, feedback such as the total number of reward points earned to date can be provided to a user if a user or customer passively responds to or closes an ad or ad content. In another instance, a user or customer can request or obtain feedback at any time. In this manner, the user or customer can learn when he or she may have earned a sufficient amount of points to be eligible for, for example, printer supplies. The user or customer may want to observe the points earned in a single day or other time period, or the points earned in a particular recent transaction or print job. In any instance, feedback generated by the ad match engine 128 can be used by a user or customer to consider increasing his or her response to subsequent ads or ad content. In addition, feedback generated by the ad match engine 128 can be used by the engine 128 in determining subsequent ad costs for one or more advertisers.

In one embodiment, a user profile can be updated with some or all of the feedback generated in block 222. For example, using feedback associated with a user providing active-type responses to ads or ad content, a user profile can be modified to account for a user's interest in particular types of ads or ad content.

The method 200 ends at block 222. Other methods for providing a printing incentive or other type of incentive process or method can include some or all of the above elements as well as other elements in accordance with the invention.

In use, embodiments of the invention, in particular, the method 200 of FIG. 2 can provide benefits to a user or customer, advertisers, and to an OEM or an ad match engine host or administrator. In this manner, the “targetedness” or relevance of the ads or ad content can be increased over time. This can increase the value of subsequent ads and ad content to the advertiser, thereby increasing the reward potential to the user, and the profit potential to an OEM.

FIG. 3 illustrates an example process or method flow for providing a printing incentive or incentive program according to an embodiment of the invention. The system 100 described in FIG. 1 can be used to implement the process or method 300 of FIG. 3. Other embodiments of process flows and methods for providing printing incentives can include fewer or greater numbers of steps, and may include some or all of the steps described in FIG. 3. Arrows in the process or method flow are intended to indicate signal and/or data flow from one functional component block to another, and the order of execution of each numbered functional component block is not necessarily consecutively performed, but rather, the numbered functional component blocks are for the convenient reference to the accompanying description below.

The process or method 300 of FIG. 3 begins at block 302. In block 302, one or more particular advertisers choose to participate in a printing incentive program. In the embodiment shown, the ad match engine 128 can store a corresponding indication associated with each advertiser's participation in, for example, an advertiser registration database such as 120 or other data storage device.

Block 302 is followed by block 304, in which each of the participating advertisers can select criteria for customers to target. In the embodiment shown, the ad match engine 128 can permit each of the participating advertisers to select one or more criteria for customers to target. In one example, Advertiser 1 can select criteria such as “outdoors” and “water sports”; Advertiser 2 can select criteria such as “kayaking” and “whitewater”; Advertiser 3 can select criteria such as “outdoors” and “camping”; and Advertiser 4 can select criteria such as “water sports” and “canoes”. The criteria can be provided to the advertisers based on information provided by one or more users in a user profile described with respect to block 306. Based at least in part on a relative level of “targetedness” or relevance to information associated with a user profile, the participating advertiser can pay a relatively low, medium, or high payment amount for a targeted ad associated with selected criteria. The ad match engine 128 can store the advertiser-selected criteria and other advertiser-associated information in the advertiser registration database 120 or other data storage device.

The method 300 continues at block 306, in which customer-entered personal information is received. In the embodiment shown, a user or customer can create a user profile as described above with respect to block 206 in FIG. 2. The user profile can include information associated with the user or customer, and which may be of interest or relevance to one or more advertisers. For example, a user or customer can designate, enter, or select “outdoors” as an interest or hobby within his or her user profile. The ad match engine 128 can store the user profile and other user or customer-associated information in the user registration database 116 or other data storage device.

The method 300 continues at block 308, in which at least a portion of user profile information is compared to advertiser criteria. In the embodiment shown, the ad match engine 128 can compare customer interest and hobby information stored in a user registration database, such as 116, with participating advertiser criteria stored in an advertiser registration database, such as 120. Other comparisons between information stored in a user registration database 116 and the advertiser registration database 120 can be performed. For example, the ad match engine 128 can perform a comparison of user profile input “outdoors” to advertiser-selected criteria, including criteria such as “outdoors”, “water sports”, “kayaking”, “white water”. “camping”, and “canoes”. The ad match engine 128 can determine matching inputs and criteria, and can also facilitate contextual matching. An example of comparing and matching a user profile to advertiser criteria is described in greater detail below in FIG. 4.

The method 300 continues at block 310, in which a printing event triggers an ad to be output to a customer. In this embodiment, the ad match engine can detect or otherwise receive a signal associated with a printing event, such as a signal associated with a print command input to a client device such as 104a-n, also known as a “print job”. When a signal associated with a printing event is detected or otherwise received, the ad match engine 128 can facilitate the output of an ad or particular ad content to a customer associated with the printing event. For example, when a print job is initiated by a customer entering a print command at a client device, such as 104a, the delay between initiating and completing a print job can be used to output or display an ad or particular ad content on an output device, such as a display, associated with the client device 104a. In this example, two ads including hyperlinks can be output to a display associated with the customer. In other embodiments, other types of ads, ad content, video feeds, or electronic promotion mediums can be output. In any instance, the ad match engine 128 can retrieve or otherwise facilitate the retrieval of an ad or ad content from one or more advertisers, and can transmit or otherwise facilitate the transmission of the ad or ad content from a database, such as the advertiser registration database 120, to the client device 104a associated with the customer. In some instances, an ad or ad content can be ultimately transmitted by an ad match engine and output to a display associated with a printer 106 or other output device.

In one embodiment, the printing event trigger is the performance of a “print job.” In comparison to conventional advertising methods wherein the initiation or performance of an Internet or network search results in ads to be selected and charges applied to the advertiser, this embodiment costs the user in the form of printer supplies, in particular, printer ink, toner and/or media. In this manner, this embodiment is a self-limiting means to the user, and is can minimize advertising fraud which can be prevalent with other advertising methods.

In one embodiment, the functions associated with blocks 308 and 310 can be interchanged, or performed simultaneously and in real time depending on the processing speed associated with the system, such as 100, and method 300.

Block 310 is followed by block 312, in which a user response to the ad or ad content is received. In the embodiment shown, the ad match engine 128 receives an indication of a user response to an ad or ad content. Continuing the above example, when presented with two ads including hyperlinks, the customer can select the ad associated with Advertiser 1, and not click the other ad. The customer's response to an ad associated with Advertiser 1 is received by the ad match engine 128, and the engine 128 also determines that the customer did not click on the other ad. Signals or other indications corresponding to the relative levels of the customer's response are received by the ad match engine 128, and associated data is stored by the engine 128 in the user registration database 116 or other data storage device.

The method 300 continues at block 314, in which a reward or benefit is calculated based at least in part on the user response to an ad or ad content. In the embodiment shown, the ad match engine 128 calculates a reward or benefit based at least in part on the user response to an ad or ad content. Continuing the above example, based at least in part on the user response to an ad or ad content, reward or benefit points can be calculated by the ad match engine 128 and credited to the user's or customer's account. The ad match engine 128 can calculate an relatively greater amount of reward or benefit points, such as 4 points, for the relatively greater amount of user response to or interaction with an ad or ad content associated with Advertiser 1. In this example, the customer may receive 2 points for the amount of information provided in his or her user profile, and 2 points for clicking on the ad associated with Advertiser 1. In the instance that a user did not respond at all to the other ad, no reward points are awarded to the customer. In all instances, the reward points can be credited by the ad match engine 128 to a user or customer account stored in a user rewards database, such as 118, or other data storage device.

The method 200 continues at block 316, in which an ad cost is determined. In the embodiment shown, ad match engine 128 calculates an ad cost based at least in part on the user or customer response to an ad or ad content. Continuing the above example, based at least in part on the user response to an ad or ad content, an ad cost, such as 8 points to Advertiser 1 and 2 points to Advertiser 2, is calculated by the ad match engine 128 and charged to each advertiser's account. The ad match engine 128 calculates a relatively greater ad cost for the relatively greater amount of user response to or interaction with an ad or ad content associated with Advertiser 1. In this example, 2 points can be assessed to Advertiser 1 for the matching user profile and advertiser-selected criteria, and 6 points can be assessed for the customer's selection of the ad or ad content associated with Advertiser 1. In the instance that a user ignores an ad associated with the advertiser, a relatively low ad cost such as 2 points can be charged to the Advertiser 2 account. For Advertiser 2, 2 points can be assessed for the matching user profile and advertiser-selected criteria. In any instance, the ad costs calculated by the ad match engine 128 are be stored in an account associated with the advertiser, and stored in an advertiser cost database, such as 122, or other data storage device.

In one embodiment, an OEM can be awarded or assessed points during the ad cost determination. In the above example, an OEM can be awarded 6 points, which may be the difference between what an advertiser pays and the customer receives.

The method 300 continues at block 318, in which feedback is provided to an advertiser based at least in part on a user or customer response to an ad or ad content. In the embodiment shown, the ad match engine 128 generates and transmits feedback to the advertisers based at least in part on one or more user or customer responses to ads or ad content associated with each respective advertiser. For example, positive feedback can be provided to Advertiser 1 since the associated ad or ad content was particularly successful in eliciting an active-type response from a user or customer. Likewise, negative feedback can be provided to Advertiser 2 since the associated ad or ad content was not particularly successful in eliciting an active-type response, and instead, generated a passive-type response from a customer. In any instance, feedback generated by the ad match engine 128 can be used by an advertiser to improve the ads or ad content. In addition, feedback generated by the ad match engine 128 can be used by the engine 128 in determining subsequent ad costs for one or more advertisers.

The method 300 continues at block 320, in which feedback is provided to a user or customer based at least in part on a user or customer response to an ad or ad content. In the embodiment shown, ad match engine 128 generates and transmits feedback to a user or customer based at least in part on one or more user or customer responses to ads or ad content. For example, feedback such as a number or reward points earned, such as 4 points, can be provided to the user when the user or customer actively responds to a particular ad or ad content. Furthermore, a user profile associated with the customer can be updated with some or all of the feedback generated. For example, using feedback associated with a user providing active-type responses to ads or ad content, a user profile can be modified to account for a user's interest in particular types of ads or ad content. In any instance, feedback generated by the ad match engine 128 can be used by a user or customer to consider increasing his or her response to subsequent ads or ad content. In addition, feedback generated by the ad match engine 128 can be used by the engine 128 in determining subsequent ad costs for one or more advertisers.

The method 300 ends at block 320. Other methods for providing a printing incentive process or method can include some or all of the above elements as well as other elements in accordance with the invention.

FIG. 4 illustrates an example process or method flow for providing a printing incentive or incentive program according to an embodiment of the invention. In particular, the method 400 further describes an example of comparing and matching a user profile to advertiser criteria. The system 100 described in FIG. 1 can be used to implement the process or method 400 of FIG. 4. Other embodiments of process flows and methods for providing printing incentives can include fewer or greater numbers of steps, and may include some or all of the steps described in FIG. 4. Arrows in the process or method flow are intended to indicate signal and/or data flow from one functional component block to another, and the order of execution of each numbered functional component block is not necessarily consecutively performed, but rather, the numbered functional component blocks are for the convenient reference to the accompanying description below.

The method begins at block 402, in which a printing event trigger is detected or otherwise received. Similar to block 212, an ad match engine such as 128 can detect or otherwise receive a signal associated with a printing event. As described above, a printing event can include, but is not limited to, a signal associated with printing a document using an output device such as a printer 106, a signal associated with a print command input to a client device such as 104a-n, a signal associated with a print command communicated from a printer driver, such as 110, to an output device such as printer 106, a signal associated with scanning a document, a signal associated with reading or receiving an image from a memory card, a signal associated with reading or receiving a document from a memory card, a signal associated with reading or receiving an image from a camera, a signal associated with reading or receiving an image from a mobile communication device, a printer supplies intervention, a printer POR (power or reset command). When a signal associated with a printing event is detected or otherwise received, the ad match engine 128 can facilitate the output of an ad or particular ad content to a customer associated with the printing event.

Block 402 is followed by block 404, in which information associated with a customer is received. In this embodiment, the ad match engine 128 can receive information such as a user profile. In addition, the ad match engine 128 can receive information associated with at least one advertiser, such as a list of keywords or criteria for customers to target. Furthermore, the ad match engine 128 can receive information associated with one or more printer event triggers.

Block 404 is followed by block 406, in which a security check is performed. In this embodiment, a hardware security module such as a 130 in FIG. 1, or the ad match engine 128, can perform a security check to ensure either or both device security and user validation. For example, the hardware security module 130 can communicate with either or both the printer ASIC 112 and print driver 110 to verify that a user not only has an output device such as a printer 106, but that the printer 106 is in use. The hardware security module 130, which in some embodiments can be embedded in the application server 126 as a separate module stored in memory, can communicate with these devices, and thus provide suitable security.

In another embodiment, an additional measure of security imposed by the ad match engine 128 is user validation. During creation of a user profile for each user or customer, such as in 206 and 208 of FIG. 2, suitable personal information, such as a mailing or shipping address and/or credit card number, can be obtained and validated. Since the user expects to receive printer supplies directly from the OEM as his incentive for participation in the method and system, the user should provide this information.

Block 406 is followed by block 408, in which at least one keyword associated with an advertiser is compared to a portion of information associated with the customer. In this embodiment, the ad match engine 128 performs a search of the user registration database 116 and the advertiser registration database 120, and compares information to match user information and advertiser information.

Block 408 is followed by block 410, in which a display or output is generated. In this embodiment, the ad match engine 128 can determine based at least in part on the comparison, advertising content to be output or displayed to the customer. The ad match engine 128 can determine one or more ads or ad content to output or display to the customer based at least in part on the comparison between the user information and the advertiser information.

Block 410 is followed by block 412, in which a return is generated. In this embodiment, the ad match engine can determine or otherwise receive a user response to an ad or ad content. In addition, based at least in part on the information associated with the printer customer, the ad match engine 128 can determine a benefit to provide to the printer consumer. Furthermore, the ad match engine 128 can determine an ad cost associated with each advertiser.

Block 412 is followed by 414, in which the method 400 ends. Other methods for providing a printing incentive process or method can include some or all of the above elements as well as other elements in accordance with the invention.

FIG. 5 illustrates an example process or method flow for providing a printing incentive or incentive program according to an embodiment of the invention. In particular, the method 500 further describes implementation and use of an advertising ink cartridge, similar to 132 in FIG. 1, to provide advertising content to a printer customer. The system 100 described in FIG. 1 can be used to implement the process or method 500 of FIG. 5. Other embodiments of process flows and methods for providing printing incentives can include fewer or greater numbers of steps, and may include some or all of the steps described in FIG. 5.

The method 500 begins at block 502. In block 502, an indication associated with an advertising ink cartridge is received. In this embodiment, an advertising ink cartridge such as 132 in FIG. 1 can be mounted or otherwise installed with respect to an output device, such as printer 106. The advertising ink cartridge 132 can be detected or facilitate transmission of an indication to an ASIC, processor, or memory associated with the printer 106. The indication identifies the advertising ink cartridge as adapted to provide advertising content to a printer customer. For example, an advertising ink cartridge 132 can set one or more bits in an ASIC, such as 112, to format pages for printing ads or ad content during a print job.

In one embodiment, an ASIC such as 112 can prompt a user or customer with one or more questions to gather information associated with the user or customer. The ASIC can communicate with the user or customer via an output device, such as a display, associated with the printer 106 or client device 104a-n. Each of the questions provided by the ASIC 112 can be previously stored or otherwise retrieved by the ASIC 112 via a network, such as 102.

Block 502 is followed by block 504, in which information associated with a printer customer is received. In this embodiment, a user or customer can respond to various questions and prompts from the ASIC 112, and provide personal information in response to the questions and prompts. The user or customer can communicate with the ASIC 112 via an output device, such as a keyboard or mouse, associated with the printer 106 or client device 104a-n. Personal information can include, but is not limited to, a name, address, phone number, a zip code, an Internet protocol (IP) address, user interests, user profile information, user identification information, printing frequency information, printing device information, e-mail address, hobby information, interest information, hardware and peripheral information, printer type, and other personal or user identification information.

Block 504 is followed by block 506, in which ad content is output based at least in part on the information associated with the printer customer. In this embodiment, when a signal associated with a printing event is detected or otherwise received, an ad match engine such as 128 can facilitate the output of an ad or particular ad content to a customer associated with the printing event. For example, when a print job is initiated by a customer entering a print command at a client device, such as 104a, the delay between initiating and completing a print job can be used to output or display an ad or particular ad content on an output device, such as a display, associated with the client device 104a. The ad match engine 128 can retrieve or otherwise facilitate the retrieval of an ad or ad content from one or more advertisers, and can transmit or otherwise facilitate the transmission of the ad or ad content from a database, such as the advertiser registration database 120, to the client device 104a associated with the customer. The various functionality associated with an ad match engine is described above with respect to FIGS. 1-4. In some instances, an ad or ad content can be ultimately transmitted by an ad match engine and output to a display associated with a printer 106 or other output device. An ad or ad content can include, but is not limited to, a new window, a video ad, an audio ad, a website, a webpage, a link to a website or webpage, an e-mail, a message, a voice mail, a fax, or alphanumeric text advertising a product or service. In the instance a user or customer does not respond to any questions or prompts, or if little or no information associated a printer customer is received, one or more predefined default-type ads or ad content can be output to the user or customer.

In one embodiment, ads or ad content can be formatted so that ads or ad content can be specific to the print job. Specific formatting can include, but is not limited to, including ads or ad content on every page, on every “nth” page of a print job, and the size and frequency of the ads or ad content.

In one embodiment, an advertising ink cartridge can be provided at different price points with different “levels” of ads or ad content. Different levels of ads or ad content can be by setting one or more bits in an ASIC or printhead to different values. In this manner, specific formatting and frequency can be achieved, such as the amount of ads per page, the size of ads on the page, or how often the ads get printed.

The method 500 ends at block 506. Other methods for providing a printing incentive process or method can include some or all of the above elements as well as other elements in accordance with the invention.

FIGS. 6 and 7 illustrate example ads or ad content provided by a printing incentive method or incentive program according to an illustrative embodiment of the invention. In these examples, the ads or ad content can be in the form of one or more images, graphics, or other combinations of alphanumeric text and pictures. In FIG. 6, one or more scaled images 600 can be to sized fit within a defined border region 602 of a single page document 604. The ads or ad content associated with the scaled image 600 can be printed on the outside of the border region 602, but still within the printable area for any given paper size. In FIG. 7, images 700 can be printed on a single page document 702, but on every “nth” page, ads or ad content associated with the images 700 can be output. This can also be accomplished by having the first and/or last page of a print job include ads or ad content. Other embodiments of ads or ad content can exist in accordance with other embodiments of the invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method of providing advertising content to a customer, the method comprising:
receiving information associated with a customer;
receiving information associated with at least one advertiser;
associating at least one keyword with the at least one advertiser;
comparing the at least one keyword to a portion of information associated with the customer; and
based at least in part on the comparison, outputting advertising content to the customer.

2. The method of claim 1, wherein the information associated with a customer comprises at least one of the following: a name, an address, a phone number, a zip code, an Internet protocol (IP) address, user interests, user profile information, user identification information, printing frequency information, printing supply or other consumable usage information, or printing device information.

3. The method of claim 1, wherein the information associated with at least one advertiser comprises at least one of the following: a name, an address, a phone number, a zip code, an Internet protocol (IP) address, products offered by the advertiser, services offered by the advertiser, types of consumers the advertiser is interested in, advertiser profile information, advertiser identification information, demographic information, or a keyword.

4. The method of claim 1, wherein the at least one keyword comprises at least one of the following: a customer interest, a place, a hobby, a sport, an activity, a color, an object, or a brand name.

5. The method of claim 1, wherein the advertising content comprises at least one of the following: a new window, a video ad, an audio ad, a website, a webpage, a link to a website or webpage, an e-mail, a message, a voice mail, a fax, or alphanumeric text advertising a product or service.

6. The method of claim 1, wherein outputting advertising content to the customer is initiated by the receipt of an indication associated with a print-related event.

7. The method of claim 7, wherein the print-related event comprises at least one of the following: selecting a print command, printing on a printer device, transmitting a document to a printer for printing, transmitting a document to a third-party for printing, scanning a document, reading or receiving an image from a memory card, reading or receiving a document from a memory card, reading or receiving an image from a camera, reading or receiving an image from a mobile communication device, a printer supplies intervention, or a printer power or reset (POR) command.

8. The method of claim 1, further comprising:
based at least in part on the information associated with the printer customer, determining a benefit to provide to the printer consumer.

9. The method of claim 8, wherein the benefit comprises at least one of the following: at least one point in a reward program, a monetary amount, a coupon, a discount, a product, a service.

10. The method of claim 1, further comprising:
receiving an indication associated with at least one selection of advertising content by the customer; and
based at least in part on the selection, determining an additional benefit to provide to the printer customer.

11. The method of claim 10, wherein at least one selection of advertising content by the customer comprises at least one of the following: closing a window associated with the advertising content, clicking on the advertising content, submitting data in response to the advertising content, making a purchase in response to the advertising content.

12. The method of claim 10, wherein the additional benefit comprises at least one of the following: at least one point in a reward program, a monetary amount, a coupon, a discount, a product, a service.

13. A method for providing advertising content to a printer customer, the method comprising:
receiving an indication associated with an advertising ink cartridge;
receiving information associated with a printer customer; and
outputting ad content based at least in part on the information associated with the printer customer.

14. The method of claim 13, wherein receiving an indication associated with an ink cartridge comprises detecting an advertising ink cartridge.

15. The method of claim 13, wherein the ink cartridge is adapted to provide ad printing instructions to a printhead associated with an output device.

16. The method of claim 13, wherein receiving information associated with a printer customer comprises prompting the printer customer to enter personal information.

17. The method of claim 13, further comprising:
receiving information associated with at least one advertiser; and
comparing the information associated with a printer customer with information associated with at least one advertiser.

18. The method of claim 13, wherein outputting ad content based at least in part on the information associated with the printer customer is initiated when a print job begins.

19. The method of claim 13, wherein the ad content can be modified by at least one of the following: amount of ads per page; size of ads per page; frequency of ads printed; location of ads on a page; or frequency of ads per number of pages.

20. The method of claim 13, further comprising charging the advertiser associated with the ad content for a delivery of the ad content to the printer customer.

21. A system for providing advertising content to a printer customer, comprising:
a processor adapted to:
receive an indication associated with an advertising ink cartridge;
receive information associated with a printer customer; and
output ad content based at least in part on the information associated with the printer customer.
